(19) United States
(12) Patent Application Publication
(10) Pub. No.: US 2026/0322914 A1
(43) Pub. Date: Oct. 15, 2026

(54) SYSTEM AND METHOD FOR LOCATION-BASED SCREEN TIME RESTRICTION ON ELECTRONIC DEVICES

(71) Applicant: Scott Frederick Harvey, Sonoma, CA (US)

(72) Inventor: Scott Frederick Harvey, Sonoma, CA (US)

(73) Assignee: ScreenZen LLC, Sonoma, CA (US)

(21) Appl. No.: 19/643,556

(22) Filed: Apr. 9, 2026

Related U.S. Application Data
(60) Provisional application No. 63/785,796, filed on Apr. 9, 2025.

(51) Int. Cl. H04M 1/72457; H04M 1/72463

(52) U.S. Cl. CPC H04M 1/72457; H04M 1/72463

(57) ABSTRACT

Described herein is a location-based electronic device screen-time limiting system comprising one or more beacons configured to transmit a wireless location-based signal; a mobile application having a screen locking module, a screen unlocking module, a communication module, and a compliance verification module; wherein the communication module collects a plurality of wireless location-based signals over a time interval, computes a representative signal statistic, and determines whether electronic devices are in-zone or out-of-zone using boundary hysteresis and temporal smoothing; wherein the screen locking module prevents access to applications and device functions when devices are in-zone; wherein the screen unlocking module grants access when devices are out-of-zone; wherein the system includes autonomous self-healing to restore degraded wireless monitoring; and wherein the compliance verification module transmits heartbeat signals indicating enforcement-active state and permission state to enable compliance monitoring.

### CROSS-REFERENCE TO PRIOR APPLICATION

The present application claims priority and benefit of U.S. Provisional Patent Application No. 63/785,796, filed on Apr. 9, 2025, which application is incorporated by reference to the extent permitted by applicable law.

### FIELD OF THE INVENTION

The present invention relates to a system for limiting screen time on electronic devices, and more particularly, to limiting screen time on electronic devices based on location-based data.

### BACKGROUND OF THE INVENTION

In recent years, the widespread adoption of electronic devices such as smartphones, tablets, and computers has led to concerns regarding excessive screen time and its associated negative effects on users'health and well-being. Prolonged exposure to digital screens has been linked to issues such as eye strain, sleep disruption, reduced productivity, and behavioral problems, particularly among children and adolescents. While various parental control applications and built-in device settings allow users to impose screen time limits, these existing solutions often rely on manual enforcement, are easily bypassed by tech-savvy users, or lack the flexibility needed to adapt to different usage contexts. Accordingly, there remains a need for an improved system for regulating screen time that provides an effective, adaptable, and tamper-resistant approach to limiting excessive device use.

However, traditional approaches rely on static time-based restrictions. These approaches are rigid and do not tailor specifically to each user. Therefore, a user-specific or location specific system that is low-cost and effective for everyday use is desired.

### SUMMARY OF THE INVENTION

The present invention provides a location-based electronic device screen-time limiting system having one or more beacons configured to transmit a wireless location-based signal, a mobile application executable on one or more electronic devices. In some embodiments, the mobile application includes a screen locking module, a screen unlocking module, and a communication module. In some embodiments, the communication module is configured to receive a plurality of wireless location-based signals from the one or more beacons over a time interval when the one or more electronic devices are within a coverage range of at least one of the one or more beacons. In some embodiments, the communication module is configured to compute a representative signal statistic from the plurality of wireless location-based signals. In some embodiments, the communication module is configured to determine whether the one or more electronic devices are in-zone or out-of-zone based on the representative signal statistic. In some embodiments, determining whether the one or more electronic devices are in-zone or out-of-zone comprises applying boundary hysteresis such that a threshold for determining entry into the coverage range is different from a threshold for determining exit from the coverage range. In some embodiments, the screen locking module is configured to apply temporal smoothing to the plurality of wireless location-based signals and to prevent access to one or more applications, websites, and device functions on the one or more electronic devices when the one or more electronic devices are determined to be in-zone. In some embodiments, the screen unlocking module is configured to grant access to the one or more applications, websites, and device functions on the one or more electronic devices when the one or more electronic devices are determined to be out-of-zone.

In some embodiments, the one or more beacons transmit the wireless location-based signal via Bluetooth.

In some embodiments, the coverage range is determined by a received signal strength indicator (RSSI) threshold, and wherein the representative signal statistic comprises at least one selected from the group consisting of: a moving average, a median, and a weighted average of RSSI measurements.

In some embodiments, the one or more beacons are configurable to operate in a plurality of range modes, each range mode corresponding to a different RSSI threshold; and wherein the one or more beacons are configured to transmit the wireless location-based signal via ultra-wideband (UWB) ranging, and wherein the plurality of wireless location-based signals comprise UWB distance measurements.

In some embodiments, the restriction settings for the one or more applications, websites, and device functions are modifiable only when the one or more electronic devices are determined to be in-zone for an allowed-use-zone beacon or out-of-zone for all restricted-zone beacons.

In some embodiments, the screen locking module prevents access to selected device functions while permitting access to other device functions.

In some embodiments, the one or more beacons are individually configurable as a restricted-zone beacon and at least one of the one or more beacons is configurable as an allowed-use-zone beacon.

In some embodiments, once the one or more electronic devices have been determined to be in-zone, if the communication module subsequently becomes unable to receive the wireless location-based signal, the screen locking module continues to prevent access until a trusted unlock condition occurs.

In an alternate embodiment, a location-based electronic device screen-time limiting system includes one or more electronic devices, each electronic device having an operating system that imposes background execution constraints, a mobile application executable on the one or more electronic devices, wherein the mobile application includes a locking module, a communication module, and a screentime monitoring module; one or more beacons configured to transmit a wireless signal. In some embodiments, the communication module includes a wireless scanning service configured to detect the wireless signal from the one or more beacons via a wireless advertising channel. In some embodiments, the locking module is configured to restrict access to one or more applications on the one or more electronic devices upon detection of the wireless signal. In some embodiments, the screentime monitoring module is configured to detect that the wireless scanning service has become interrupted. In some embodiments, detecting that the wireless scanning service has become interrupted comprises at least one selected from the group consisting of detecting that the wireless scanning service has been terminated by the operating system; detecting that a number of received wireless signals within a rolling time window has fallen below a minimum threshold; and detecting that a wireless adapter on the respective electronic device has been disabled. In some embodiments, upon detection that the wireless scanning service has become interrupted, the screentime monitoring module is configured to automatically initiate one or more recovery actions without requiring direct user intervention, the one or more recovery actions comprising at least one selected from the group consisting of detecting an attempt by a user to access one of the one or more restricted applications and reinitiating the wireless scanning service; reinitiating the wireless scanning service via a background process; and initiating one or more scheduled recovery events that periodically verify and restore the wireless scanning service. In some embodiments, after performing the one or more recovery actions, the screentime monitoring module re-determines whether the one or more electronic devices are within a coverage range of the one or more beacons and the locking module restricts access based on the re-determined zone state, and permits access when not within the coverage range.

In some embodiments, the screentime monitoring module detects the attempt to access one of the one or more restricted applications only when a current time falls within a predefined restriction schedule.

In some embodiments, the wireless scanning service detects the wireless signal via a Bluetooth advertising channel.

In some embodiments, the screentime monitoring module operates as a background process independent of the wireless scanning service.

In some embodiments, the screentime monitoring module is further configured to detect the attempt to access one of the one or more restricted applications based on at least one of: application launch, a predefined schedule, and a usage threshold.

In an alternate embodiment, a location-based electronic device screen-time limiting system includes a plurality of electronic devices associated with a plurality of users; a mobile application installed on each of the plurality of electronic devices, wherein the mobile application includes a locking module, a communication module, and a compliance verification module; and one or more beacons configured to transmit a wireless location-based signal, wherein the communication module of the mobile application is configured to receive the wireless location-based signal when a respective electronic device is within a coverage range of the one or more beacons. In some embodiments, the locking module is configured to restrict access to the respective electronic device upon receipt of the wireless location-based signal. In some embodiments, a cloud-based server communicatively coupled to the plurality of electronic devices. In some embodiments, the compliance verification module on each of the plurality of electronic devices is configured to determine an enforcement-active state indicating whether the respective electronic device is actively participating in restriction enforcement, determine a permission state indicating whether required restriction-related permissions and capabilities are enabled on the respective electronic device; and transmit a heartbeat signal to the cloud-based server, the heartbeat signal including data indicating the enforcement-active state and the permission state. In some embodiments, the cloud-based server is configured to aggregate the heartbeat signals from the plurality of electronic devices; and provide compliance status data to an administrator. In some embodiments, the compliance status data indicates which of the plurality of electronic devices are actively enforcing restrictions and which have required permissions enabled.

In some embodiments, determining the permission state comprises at least one selected from the group consisting of: querying an operating system interface to determine whether screentime restriction permissions are enabled; performing local optical character recognition on a screentime settings screen to validate which applications are selected for restriction; and querying a local validation module to verify restriction configuration.

In some embodiments, the compliance status data includes at least one of a percentage of uptime, a last active timestamp, and an identification of users with inactive restriction settings.

In some embodiments, the heartbeat signal is transmitted by at least one of the communication module, a screentime monitoring service, and a background process on the respective electronic device.

In some embodiments, the cloud-based server is further configured to provide an administrative dashboard displaying the compliance status data for the plurality of users.

In some embodiments, the administrator is associated with at least one of: a school, a business, and a family group.

In some embodiments, the one or more beacons are configured to transmit the wireless location-based signal only during predefined time periods.

### BRIEF DESCRIPTION OF THE DRAWINGS

The features of the exemplary embodiments of the present invention will be described with reference to the following drawings, where like elements are labeled similarly, and in which:

FIG. 1 is a schematic diagram of a first embodiment of a location-based screen-time limiting system according to the present disclosure;

FIG. 2 is a schematic diagram of a mobile application of the location-based screen-time limiting system according to the present disclosure;

FIG. 3 is a flow diagram of the mobile application according to the present disclosure;

FIG. 4 is a flow diagram of a screen locking module of the mobile application, according to present disclosure;

FIG. 5 is a flow diagram of a screen unlocking module of the mobile application, according to present disclosure;

FIG. 6 is a flow diagram of an analytics and feedback module of the mobile application, according to present disclosure;

FIG. 7 is a schematic diagram of multiple electronic devices within range of one or more beacons of the location-based screen-time limiting system according to the present disclosure;

FIG. 8 is a schematic diagram of multiple devices within range of one or more beacons of the location-based screen-time limiting system according to the present disclosure;

FIG. 9 is a flow diagram of an autonomous self-healing mechanism of the mobile application, according to present disclosure; and

FIG. 10 is a flow diagram of a compliance verification module of the mobile application, according to present disclosure.

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION OF THE EMBODIMENTS

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

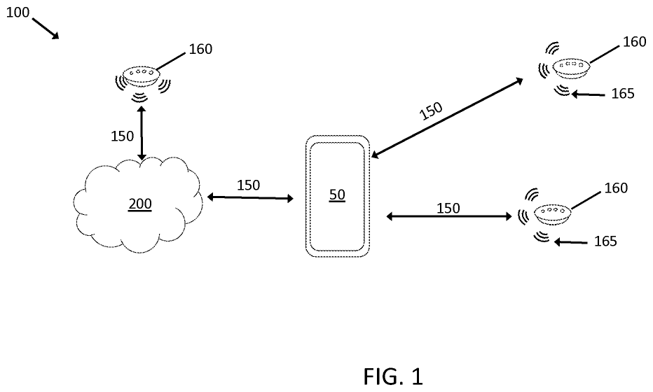

FIG. 1 depicts an exemplary embodiment of a location-based electronic device screen-time limiting system having a mobile application and one or more beacons that create a location-based restricted use zone. The present disclosure imposes location-based restricted use rather than rigid usage limiters of electronic devices such that a user can have a customized system and method for reducing and/or limiting their usage of screen time for electronic devices. This design encourages mindful usage of an electronic device while within specific locations and/or prevents usage of the electronic devices while within specific locations, such as a school classroom, or library, or bedroom. The present disclosure implements not only location-based friction points for the user to minimize unwanted use of electronic devices, such as being within range of a beacon, but also methods such as electronic locks to prevent access, daily usage thresholds, physical NFC communications, and specific daily schedule for allowed usage.

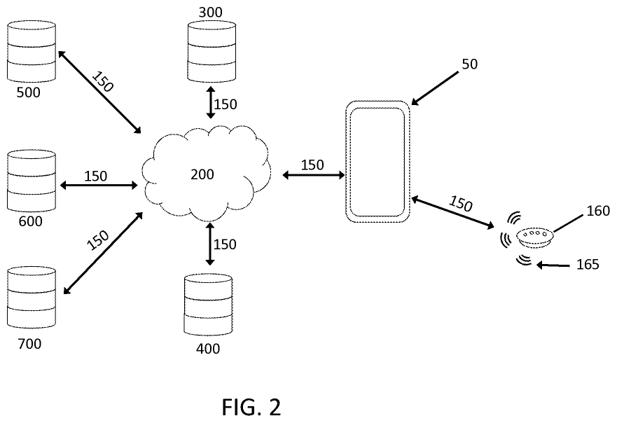

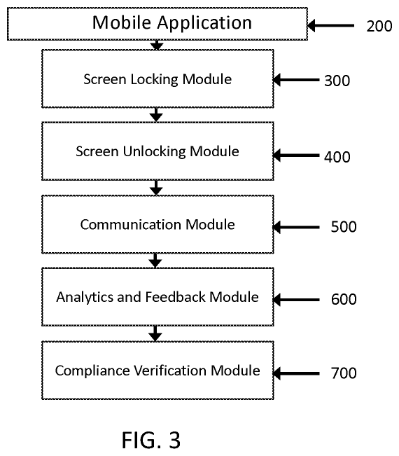

As shown in FIG. 1, the location-based electronic device screen-time limiting system 100, hereinafter ‘system 100’, includes a mobile application 200 and one or more beacons 160, each of which communicate 150 with an electronic device 50, such as a smart phone, tablet, laptop, gaming console, and the like, to limit use of the electronic devices while within range of the beacons 160. In some embodiments, as shown for example in FIG. 2, the mobile application 200 includes one or more modules that each provide specific functions to manage the access of the electronic devices 50 depending on their proximity to one or more beacons 160. For example, in some embodiments, as shown in FIG. 3, the mobile application 200 includes a screen locking module 300, a screen unlocking module 400, a communication module 500, and an analytics and feedback module 600. In some embodiments, the communication module 500 is configured to send and receive signals from beacons 160. In some embodiments, the mobile application further includes an analytics and feedback module 600 for providing analytics, messages, and feedback to a user such as motivational messages to encourage positive trends, progress reports to a user that further describes their recent usage trends, and frictional messages which help prevent unwanted usage of the electronic device. In some embodiments, the mobile application 200 further includes a compliance verification module 700 configured to verify that the screen locking module 300 is actively restricting access to the one or more electronic devices 50 and to report compliance status to a remote server. As shown in FIG. 3, the mobile application 200 uses a combination of modules 300, 400, 500, and 600, to limit usage, provide access, create friction, and provide feedback to the user.

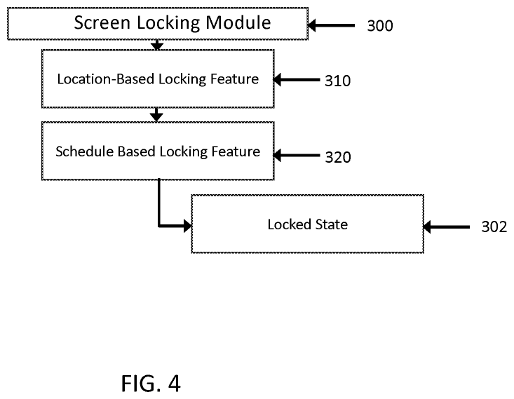

Referring now to FIG. 4, the screen locking module 300 prevents the electronic device from being used at a given time. In some embodiments, the screen locking module 300 prevents any use of the electronic device, while the device is in a locked state 302. In other embodiments, the screen locking module 300 prevents selected uses of the electronic device while the device is in the locked state 302. For example, the screen locking module 300 may prevent a user from engaging with one or more features of the electronic device, such as social media mobile applications, while allowing a user to engage with other features of the electronic device, such as placing phone calls or taking pictures. In some embodiments, the user may select which features will be locked or prevented access to while the electronic device is in the locked state 302. In some embodiments, the system 100 automatically configures which features are prevented access to, based on a plurality of factors including previous usage trends, usage thresholds, time-based features, location of the device, and user or account manager requests. In addition to which features of the electronic device are limited or prevented, the screen locking module 300 will also control how those features are locked and thus, how they can be unlocked. In some embodiments, the screen locking module 300 prevents access to the electronic device while the device is located at a specific location or within proximity to one or more beacons 160, known as the location-based locking feature 310. For example, in some embodiments, a beacon may be placed in a classroom, thereby preventing access to electronic devices that are within the classroom, or more specifically, within the range of the beacon 160 that is positioned within the classroom. In some embodiments, the screen locking module 300 applies temporal smoothing to wireless location-based signals received from beacons 160 to reduce false zone transitions caused by signal fluctuations. For example, rather than immediately locking or unlocking based on a single signal reading, the screen locking module 300 may require that the signal condition persist for a minimum duration before changing the lock state. In some embodiments, the screen locking module 300 may prevent access to the electronic device based on the given time of the day and day of the week, known as the schedule-based locking feature 320. For example, in some embodiments, the mobile application may be configured to restrict or limit use of the electronic device 50 during the times of 7:00 am-3:00 pm, a typical school day. Regardless of the criteria, once a particular criteria is met, the screen locking module 300 will communicate with the mobile application 200 to prevent access to the electronic device 50 or features within the electronic device. In some embodiments, the screen locking module 300 will not only lock the electronic device 50 currently in use, or the device which the locking criteria was met on, instead, the locking module 300 will also lock down any other electronic devices paired with the mobile application 200, the system 100, or other electronic devices on a shared network (WiFi network). For example, if a user's electronic device 50 was their smart phone, and the time of day is within the schedule of no-use for that user, the screen locking module will also lock their electronic device, cellphone, laptop, tablet, and/or gaming devices as well.

In some embodiments, the system 100 implements a fail-closed behavior such that once an electronic device 50 has been determined to be in-zone for a restricted zone, if wireless monitoring subsequently becomes unavailable due to Bluetooth adapter being disabled, wireless scanning service being terminated, or signal loss, the screen locking module 300 continues to prevent access to restricted applications, websites, and device functions until a trusted unlock condition is satisfied. Trusted unlock conditions may include detection that the device has moved outside the restricted zone based on restored wireless monitoring, passage of a scheduled time window during which restrictions are no longer required, or explicit administrator override. In some embodiments, modification of restriction settings is permitted only when the electronic device 50 is located within an allowed-use zone or outside all restricted zones. For example, a student may be unable to modify which applications are restricted while inside a classroom (restricted zone), but may adjust settings when at home or in a designated “settings modification” zone configured with an allowed-use-zone beacon 160. This prevents users from disabling restrictions while in the restricted environment.

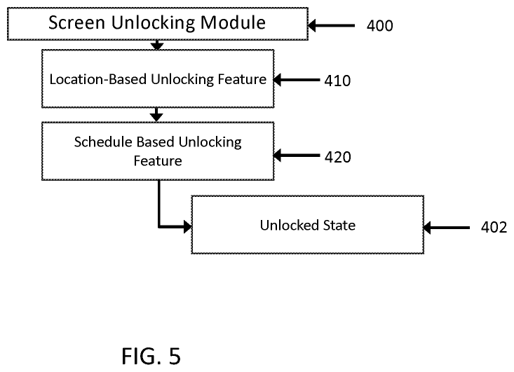

Now, referring to FIG. 5, the screen unlocking module 400 communicates with the mobile application 200 to provide the user access to the electronic devices or features within the electronic device, referred to as the unlocked state 402. However, the screen unlocking module 400 only provides access after one or more conditions are met. In some embodiments, the conditions to be satisfied to unlock the electronic device include the location of the electronic device 50, known as the location-based unlocking feature 410 and/or the specific time of day, known as the schedule-based unlocking feature 420. In some embodiments, the user may set the conditions for each of the segments 410 and 420. In some embodiments, the mobile application 200 customizes the conditions for each of the segments 410 and 420 to optimize performance. In some embodiments, a combination of approaches is utilized such that the user selects the preliminary conditions, and the mobile application updates and customizes the conditions to optimize performance. For example, a user might initially set a location-based unlocking feature to unlock the electronic device once it is determined to be out-of-zone based on wireless proximity measurements. The mobile application 200 may then increase or decrease this requirement based on the user's previous performance, time of the day, and many more factors to provide an optimal solution for the user to minimize overall usage. This could include for example, extending the restriction to leaving the range of the beacon 160 along with the passage of at least one hour of time since leaving the restricted area covered by beacon 160.

In some embodiments, the communication module 500 includes a Bluetooth communication module for communicating with one or more beacons 160. In some embodiments, the communication module 500 is configured to receive a plurality of wireless location-based signals from the one or more beacons 160 over a time interval when the one or more electronic devices 50 are within a coverage range of at least one of the one or more beacons 160. In some embodiments, the communication module 500 computes a representative signal statistic from the plurality of wireless location-based signals, such as a moving average, median, or weighted average of received signal strength indicator (RSSI) measurements, to determine whether the one or more electronic devices 50 are in-zone or out-of-zone. In some embodiments, the communication module 500 is configured to receive Bluetooth communications, WiFi communications, NFC, ultra-wideband (UWB) ranging measurements, infrared, and the like.

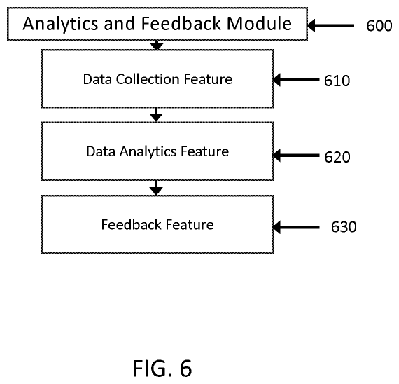

As shown in FIG. 6, the analytics and feedback module 600 collects data of the user's daily, weekly, and monthly usage, current lock settings, location data, proximity to a beacon 160, and much more to analyze and provide feedback to the user based on the above-mentioned data. In some embodiments, the analytics and feedback module 600 provides feedback to the user in the form of messages, additional friction points (electronic tasks to complete to regain access), and graphics of the user's performance. In some embodiments, the analytics and feedback module 600 provides trends and streaks to the user to further help engagement and to promote a reduction in unwanted usage. In some embodiments, the analytics and feedback module 600 includes machine learning, artificial intelligence, and language models to analyze the received data, optimize current restriction criteria and conditions, and to provide psychological motivation to the user to promote the desired outcome. As shown in FIG. 6, the analytics and feedback module 600 includes a data collection feature 610 for gathering the above-mentioned data, a data analytics feature 620 for analyzing and interpreting the data to optimize efficiency of the system 100, and a feedback feature 630 for providing motivation and other forms of feedback to the user to promote continued usage of the system 100.

In addition to the mobile application 200 and associated modules 300, 400, 500, 600, the beacons 160 can be configured to restrict or limit usage of one or more electronic devices 50. In some embodiments, the beacons 160 include a short-range Bluetooth signal transmitter for transmitting a location-based signal to one or more electronic devices 50. In some embodiments, the transmitter is capable of sending signals through other means of electronic communication including but not limited to Bluetooth, WiFi, infrared, NIR, and NFC. More particularly, in some embodiments, the beacons communicate through Bluetooth communication. In some embodiments, one or more electronic devices may pair with one or more beacons through Bluetooth communication, WiFi communications, NFC, infrared, and the like. In some embodiments, the beacons transmit periodic location-based signals to all electronic devices within range of the beacon, thereby notifying the system 100 that the electronic devices 50 are within range of the beacon. In some embodiments, where more than one device is paired with a single beacon, the system 100 may provide detailed reports describing both the devices paired with the beacon, and that device's statistics including but not limited to total restricted time and total usage time while within range of the beacon. For example, in a school setting, administrators may wish to monitor which students are bypassing the restricted use zones, which students are complying with restrictions, and those who are not paired with the beacon at all. As such, the detailed report may further include statistics and analytic data including the last time the device was paired or restricted by the specified beacon. In some embodiments, the system 100 is configured to work with all electronic devices, mobile phones, tablets, gaming consoles, computers, and other devices, including those with operating systems including Apple IOS, Android, Linux, and the like. In some embodiments, administrators may require users to upload screenshots of their device's screentime usage for specific categories of applications and websites (e.g. mobile games, social media, etc.). In some embodiments, the system 100 locally validates the user's selection of prescribed applications or application categories by employing an OCR module that recognizes the names of applications and websites displayed on the device. This on-device processing confirms that the designated applications or categories—identified as targets for restriction—are correctly selected, thereby circumventing the limitations of the one or more third party screentime API's while preserving user privacy without requiring the upload of sensitive screentime usage data.

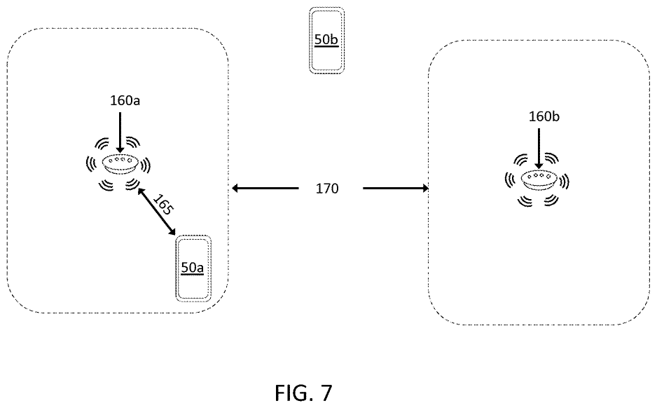

As described above, and shown for example in FIG. 7, one or more beacons can be setup in a given area to restrict or minimize usage of any number of electronic devices 50 that are paired with mobile application 200. As shown in FIG. 7, beacons 160a and 160b are positioned within a given area, and in the area are electronic devices 50a and 50b. In this example, each beacon 160a, 160b, give off a location-based signal 165 which is capable of extending and communicating with electronic devices up until the beacon range limit, shown as 170. Any devices within the range limit of the beacons 160a, 160b receive a communication signal from the respective beacon, which then communicates with the mobile application to prevent usage of the electronic device. In this example, mobile device 50a is within the range 170 of beacon 160a, and outside of the range 170 of beacon 160b. Even though, mobile device 50a is outside of the range of beacon 160b, the mobile application will begin engaging the screen locking module 300, since the device 50a is receiving a communication signal 165 from beacon 160a. Conversely, mobile device 50b is outside of the range 170 for both beacon 160a and beacon 160b, thereby allowing the mobile device to function properly since the device is unable to receive any signals from beacons 160a or 160b. Although FIG. 7, only presents two mobile electronic devices 50a, 50b, a person having ordinary skill in the art would understand that the beacons are capable of sending electronic communications to any number of devices 50 within range 170 of the respective beacons 160a, 160b. Further, in some embodiments, the term out of range is meant to display a distance away from a beacon such that the signal strength from the beacon is less than −50dBm. In some embodiments, the signal strength of the beacon can be selected by a user. For example, in some embodiments, the beacon may be switched into one of three modes, a table mode for small distance coverage (approximately 1-2 meters) and having an RSSI signal threshold greater than −50 to-60 dBM, a room mode for medium distance coverage (approximately 4-6 meters) and having an RSSI signal threshold greater than −70 to −80 dBM, and a building mode for large area coverage (approximately 10-20 meters) and having an RSSI signal threshold greater than −90 to −100 dBM. In each of the above described modes, if the RSSI signal threshold of the beacon is greater than the moving average of the signal strength being received by the electronic device 50, then the device will not have any restricted access and as such will be treated as if the device is outside of the range of the beacons 160. In some embodiments, the moving average is calculated based on the signal strengths readings within the last 5 seconds. In some embodiments, the system 100 determines whether an electronic device 50 is in-zone or out-of-zone by collecting a plurality of wireless location-based signals over a time interval and computing a representative signal statistic from the plurality of signals. For example, in some embodiments, the representative signal statistic comprises a moving average of RSSI measurements collected over the last 5 to 30 seconds. In some embodiments, the system 100 applies boundary hysteresis such that the threshold for determining entry into a zone is different from the threshold for determining exit from the zone. For example, a device may be determined to be in-zone when the representative signal statistic exceeds −70 dBm, but may remain in-zone until the representative signal statistic falls below −80 dBm, thereby preventing rapid zone transitions when a device is near the boundary. In some embodiments, the screen locking module 300 applies temporal smoothing to the plurality of wireless location-based signals to reduce false zone transitions caused by signal fluctuations or temporary obstructions.

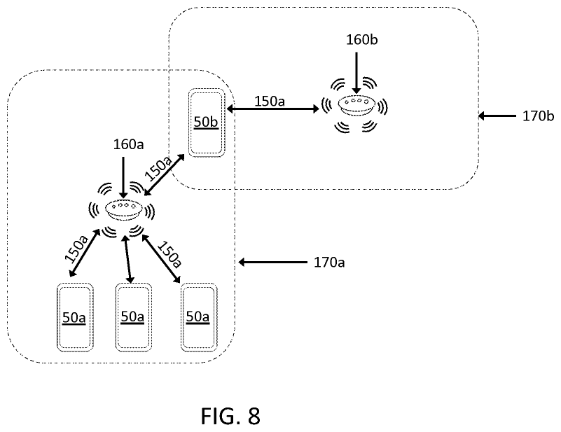

In another embodiment, as shown for example in FIG. 8, two beacons 160a, 160b may have an overlapping coverage range 170a, 170b. In such example, the coverage range 170a, 170b are defined as the maximum distance that the beacon can provide sufficient signal to an electronic device to exceed the RSSI signal threshold. In addition to selecting the distance mode for each beacon, each beacon may be configured to create a restricted zone or an allowed-use zone for electronic devices. In this example, beacon 160a has a range of 170a and is configured to create a restricted zone. The restricted zone is defined as the area encompassed within the range of the beacon, here the area represented by 170a. Conversely, beacon 160b is configured to create an allowed-use zone. The allowed-use zone is defined as the area encompassed within the range of the beacon 160b, here the area represented by 170b. As shown in FIG. 8, zones 170a and 170b overlap, and within the area of overlap is electronic device 50b. In this example, electronic devices 50a are within the restricted zone 170a and thereby receive communications 150 from beacon 160a, thereby preventing use or restricting use of the electronic devices 50a. Conversely, electronic device 50b while within range 170a and receiving communications from beacon 160a, is additionally within zone 170b and receives communications from beacon 160b. Due to receiving more than one communication from a beacon 160, the mobile application 200 will prioritize communications from allowed-use zone beacons (here shown as beacon 160b), and thereby allow use of the electronic device 50b. Therefore, in some embodiments, areas may include more than one beacon 160 and those beacons may be configured for different purposes including but not limited to restricted zones or allowed-use zones. In the event of a zone overlap, priority is given to the allowed-use zone beacons. Such situation, may be present in smaller areas including classrooms and hallways which have tight spaces and adjacent areas. In some embodiments, the range of the beacons 160 are standard and consistent between devices. In other embodiments, the range of the beacons 160 may be adjusted or calibrated to a specific area. For example, if a desired restricted use zone was a classroom, the beacons may be configured by inputting either the dimensions of the classroom, uploading blueprints of the area, or by walking the beacon around the perimeter of the area. In such case, the beacon can be calibrated to limit its range 170 to the perimeter area of the classroom, such that a student would be unable to use their electronic devices while within the classroom, however they would regain access to their electronic device once they leave the classroom. As mentioned above, the presence of the beacons 160 do not physically lock the electronic device, instead, the beacons 160 communicate with the mobile application 200 which are installed on the electronic devices and once a communication is made, the mobile application 200 will restrict usage of the electronic device.

In some embodiments, beacons may be paired with specific devices thereby preventing unwanted restrictions to some devices 50 over others. For example, at home, a parent may configure a beacon 160 to restrict use of their children's devices while the children are in the kitchen, however the parent does not want to restrict their use of their electronic devices in that area. As such, the beacons may pair with each of the children's electronic devices and be configured to restrict access, while the parent's device may pair with the beacon without any restrictions for that area. Thereby creating a parental control zone through the use of the beacons.

In some embodiments, the beacons may be configured to only send communications or signals to electronic devices within their range during specific times or schedules, similar to the schedule-based locking feature of the mobile application 200. For example, a beacon located within a classroom may be configured to restrict access of electronic devices during scheduled class times, and to not send out any communications or signals when outside of class time. Thereby transitioning the given classroom area from restricted use zones to allowed-use zones depending on the time of the day.

As shown and described in FIG. 8, beacons 160 may also be configured to create allowed-use zones in addition to restricted use zones. In some embodiments, the configuration can be controlled by the user, and in other embodiments, the configuration of the beacons may be controlled by an administrator that oversees one or more users, as for example in a classroom setting, a school administrator may utilize a plurality of beacons that are positioned across the school in areas such as classrooms, hallways, gyms, and more. The administrator may configure each beacon independently to create a unique restricted and allowed-use area map for the given overarching area. In some embodiments, system 100 may include a visual map that displays the location of each beacon and their given setting (time restrictions, range, use status). In some embodiments, machine learning and artificial intelligence may retrain and fine-tune configurations of a group of beacons to provide a more efficient use and to minimize coverage/range overlap between beacons. In some embodiments, the configurations of the beacons may be controlled by an administrator through a cloud-based server that oversees one or more users. In some embodiments, the cloud-based server 760 provides an administrative dashboard 770 that displays a visual map of all beacons 160 and their configurations, including time restrictions, range settings, and use status for each beacon.

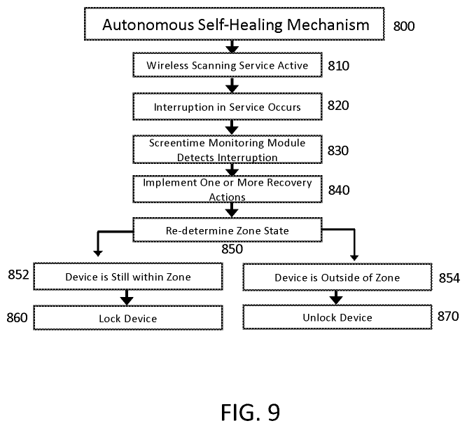

In some embodiments, as shown for example in FIG. 9, the system 100 includes an autonomous self-healing mechanism 800 to ensure continuous monitoring of wireless signals from beacons 160 despite operating system background execution constraints. The screentime monitoring module is configured to detect that the wireless scanning service has become interrupted, and to automatically initiate one or more recovery actions without requiring direct user intervention. For example, the Autonomous self-healing mechanism 800 first actively scans for wireless signals, 810; then when an interruption in service or signal occurs, 820; the screentime monitoring module detects the interruption, 830; and then implements one or more recovery actions, 840; upon recovering the signal the mechanism 800 redetermines the zone state of the device, 850; if the device is still within the zone, 852; the device will be placed in the locked state, 860; or if the device is outside of the zone, 854; the device will remain in the unlocked state, 870.

In some embodiments, detecting that the wireless scanning service has become interrupted comprises at least one selected from: detecting that the wireless scanning service has been terminated by the operating system; detecting that a number of received wireless signals within a rolling time window has fallen below a minimum threshold, indicating degraded-but-running monitoring; and detecting that a wireless adapter on the electronic device 50 has been disabled. For example, in some embodiments, if fewer than a threshold number of wireless signals have been received in a rolling 30-second time window despite the wireless scanning service remaining active, the system 100 determines that monitoring has become degraded and initiates recovery actions.

In some embodiments, upon detection that the wireless scanning service has become interrupted, the screentime monitoring module automatically initiates one or more recovery actions. The one or more recovery actions comprise at least one selected from: detecting an attempt by a user to access one of the restricted applications and reinitiating the wireless scanning service (usage-triggered recovery); reinitiating the wireless scanning service via a background process without user-visible interaction; and initiating one or more scheduled recovery events comprising multiple redundant watchdog timers that periodically verify and restore the wireless scanning service at different intervals. In some embodiments, when the wireless adapter has been disabled by the user, the screentime monitoring module detects this condition and, upon re-enablement of the adapter by the user, immediately reinitiates the wireless scanning service to restore proximity monitoring.

In some embodiments, one or more electronic devices may be paired to one or more beacons through the use of a Bluetooth advertising channel and measuring the corresponding signal strength of any surrounding Bluetooth devices (e.g., the nearest beacon). If the advertising channel signal has been force quit, for example by the user, the electronic devices may regain access during unwanted times. To prevent this, the screentime monitoring module can correlate the use of any unwanted applications with a specified schedule or area of restricted use. If this triggers, the screentime API redirects back into the mobile application 200, bringing the application into the foreground thereby allowing the restarting of the Bluetooth monitoring. In some embodiments, the screentime API may also trigger the Bluetooth scanning and connection in the background.

In some embodiments, the screentime monitoring module also initiates recovery in response to device boot events, operating system package update events, and system restart events, ensuring that wireless scanning service functionality is restored after system-level changes that may have disrupted monitoring. In some embodiments, after performing the one or more recovery actions, the screentime monitoring module re-determines whether the electronic device 50 is within the coverage range of one or more beacons 160, and the locking module 300 restricts access based on the re-determined zone state and permits access when not within the coverage range. In some embodiments, the screentime monitoring module restores proximity-processing state data after reinitiating the wireless scanning service to maintain continuity of zone determination. The screentime monitoring module operates as a background process independent of the wireless scanning service, thereby enabling multiple redundant pathways for detection and recovery. In some embodiments, a user may select an ‘Always Allow Location permissions’ selection on their mobile device to allow the mobile device to constantly search for Bluetooth signals and thereby prevent any unwanted disconnection between the electronic device and associated beacons 160.

In some embodiments, the system 100 includes a social monitoring aspect of the present disclosure. In some embodiments, a user is capable of sharing their monitoring status with one or more other users. In some cases, as briefly described above, the sharing can be used by an administrator to monitor the use of the electronic device of the user to ensure proper restrictions are in place, however, in other embodiments, the sharing may be with friends to promote social accountability regarding restricted access of the mobile device during classroom activities or the like. In such examples, one or more user's may sync their statuses with other users and may check the status of those users to see if they are active or inactive.

In some embodiments, the compliance verification module 700 is configured to determine an enforcement-active state and a permission state for the electronic device 50. The enforcement-active state indicates whether the electronic device 50 is actively participating in restriction enforcement based on proximity to beacons 160. The permission state indicates whether required restriction-related permissions and capabilities are enabled on the electronic device 50, such as screentime restriction permissions, location permissions, and Bluetooth permissions necessary for the system 100 to function properly.

In some embodiments, the compliance verification module 700 determines the permission state by at least one selected from: querying an operating system interface to determine whether screentime restriction permissions are enabled on the electronic device 50; performing local optical character recognition on a screentime settings screen to validate which applications, websites, and application categories are selected for restriction; and querying a local validation module to verify restriction configuration. For example, in some embodiments, the compliance verification module 700 may programmatically access the device's screentime API to confirm that the required application categories (such as social media, games, and entertainment) are designated as restricted.

In other embodiments, the compliance verification module 700 employs an on-device OCR module that captures and analyzes a screenshot of the screentime settings interface, recognizing the names of applications and categories displayed on the screen to confirm that the prescribed restrictions are correctly configured. This local optical character recognition validation circumvents limitations of third-party screentime APIs while preserving user privacy, as the OCR processing occurs entirely on the electronic device 50 without transmitting sensitive screentime usage data to external servers.

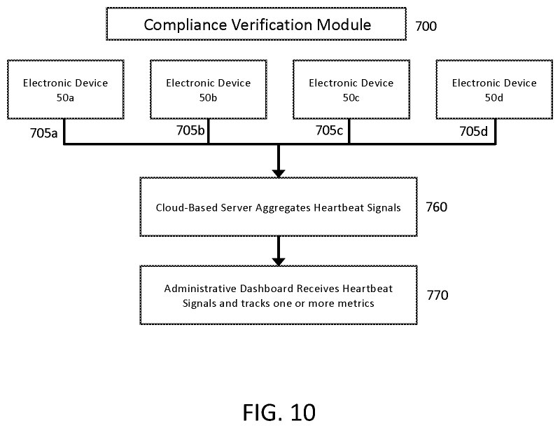

In some embodiments, as shown for example in FIG. 10, the compliance verification module 700 transmits one or more heartbeat signals 705a, 705b, 705c, 705d to a cloud-based server 760 at periodic intervals. The heartbeat signal includes data indicating: the enforcement-active state; the permission state; whether the communication module 500 is actively monitoring for wireless location-based signals from beacons 160; whether screentime restriction permissions are enabled on the electronic device 50; and which of the applications, websites, and application categories are selected for restriction. In some embodiments, the heartbeat signal further includes a monitoring liveness state reflecting whether the wireless scanning service is currently running and receiving signals from beacons 160.

In some embodiments, the heartbeat signal is transmitted by at least one of the following: the communication module 500, a screentime monitoring service, and a background process on the electronic device 50. In some embodiments, multiple local processes on the electronic device 50 are each capable of independently transmitting heartbeat signals 705 to the cloud-based server 760, thereby providing redundancy and ensuring continued transmission even if one process is terminated by the operating system. For example, if the primary communication module 500 is suspended by the operating system, a secondary background process may continue transmitting heartbeat signals to maintain compliance reporting. In some embodiments, the screentime monitoring module identifies if the transmission of heartbeat signals has been interrupted. In some embodiments, interrupted includes at least one of degraded and terminated. For example, degraded transmission may occur when heartbeat signals are being sent less frequently than expected, while terminated transmission occurs when no heartbeat signals are received for an extended period.

In some embodiments, as shown for example in FIG. 10, the cloud-based server 760 aggregates the heartbeat signals 705a-d from a plurality of electronic devices 50a-d associated with a plurality of users and calculates compliance status data. The compliance status data includes at least one selected from: a percentage of uptime for each electronic device 50, calculated as the proportion of time during which the device transmitted heartbeat signals indicating active enforcement; a last active timestamp indicating when each electronic device 50 last transmitted a heartbeat signal; and an identification of users whose restriction settings are inactive, incomplete, or improperly configured. The compliance status data indicates which of the plurality of electronic devices 50 are actively enforcing restrictions based on proximity to beacons 160 and which have the required permissions enabled on the device. In some embodiments, the cloud-based server 760 provides this compliance status data to an administrator via an administrative dashboard 770. The administrator may be associated with at least one selected from: a school, a business, and a family group. The administrative dashboard 770 displays the compliance status data for the plurality of users, enabling the administrator to identify which users are complying with restriction requirements and which users may require assistance or intervention to properly configure their electronic devices 50.

In some embodiments, the mobile application 200 further provides a privacy-preserving local status screen on each of the plurality of electronic devices 50. The privacy-preserving local status screen displays the enforcement-active state and permission state without transmitting device-specific usage data to the administrator. For example, the status screen may show whether the system 100 is currently active and restricting use of the electronic device 50, whether all required permissions are enabled, and which applications and categories are configured for restriction, all without sharing this information with the cloud-based server 760 or administrator. This enables local verification of compliance while protecting user privacy. In some embodiments, an administrator such as a teacher in a classroom environment may ask students to display their local status screens for visual inspection, allowing the teacher to verify that each student's device is properly configured and actively enforcing restrictions without requiring electronic access to the students' devices or their usage data.

In some embodiments, the mobile application 200 further provides social accountability features enabling member visibility into enforcement status within at least one selected from: a family group and an organizational unit. For example, family members may share their enforcement-active states with one another to promote mutual accountability, or students in a study group may share their restriction statuses to encourage focused work during designated study periods.

In some embodiments, the system 100 further includes a status screen which displays whether or not the system 100 is currently active and restricting use of the electronic device. In such embodiments, the system 100 does not share any data between one or more electronic devices 50. For example, an administrator can monitor one or more electronic devices by having the user of the device display the status screen to the administrator for them to determine that the system 100 is active/inactive. Such embodiment prevents unwanted data sharing and minimizes any privacy concerns a user may have. For example, in a classroom environment a teacher may ask all students to display their status screens, while the teacher observes each electronic device to ensure all students are currently following the required restrictions. Therefore, a teacher is able to determine the conformity of each student without electronically accessing the student's electronic device or the data associated with their usage for their electronic device.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A location-based electronic device screen-time limiting system comprising:
one or more beacons configured to transmit a wireless location-based signal;
a mobile application executable on one or more electronic devices, the mobile application having a screen locking module, a screen unlocking module, and a communication module;
wherein the communication module is configured to:
receive a plurality of wireless location-based signals from the one or more beacons over a time interval when the one or more electronic devices are within a coverage range of at least one of the one or more beacons;
compute a representative signal statistic from the plurality of wireless location-based signals; and
determine whether the one or more electronic devices are in-zone or out-of-zone based on the representative signal statistic;
wherein determining whether the one or more electronic devices are in-zone or out-of-zone comprises applying boundary hysteresis such that a threshold for determining entry into the coverage range is different from a threshold for determining exit from the coverage range;
wherein the screen locking module is configured to:
apply temporal smoothing to the plurality of wireless location-based signals; and
prevent access to one or more applications, websites, and device functions on the one or more electronic devices when the one or more electronic devices are determined to be in-zone; and
wherein the screen unlocking module is configured to grant access to the one or more applications, websites, and device functions on the one or more electronic devices when the one or more electronic devices are determined to be out-of-zone.

2. The location-based electronic device screen-time limiting system of claim 1, wherein the one or more beacons transmit the wireless location-based signal via Bluetooth.

3. The location-based electronic device screen-time limiting system of claim 1, wherein the coverage range is determined by a received signal strength indicator (RSSI) threshold, and wherein the representative signal statistic comprises at least one selected from the group consisting of: a moving average, a median, and a weighted average of RSSI measurements.

4. The system of claim 1, wherein the one or more beacons are configurable to operate in a plurality of range modes, wherein at least one range mode corresponds to a received signal strength indicator (RSSI) threshold, and wherein at least one range mode corresponds to ultra-wideband (UWB) ranging with the plurality of wireless location-based signals comprising UWB distance measurements.

5. The system of claim 1, wherein restriction settings for the one or more applications, websites, and device functions are modifiable only when the one or more electronic devices are determined to be in-zone for an allowed-use-zone beacon or out-of-zone for all restricted-zone beacons.

6. The system of claim 1, wherein the screen locking module prevents access to selected device functions while permitting access to other device functions.

7. The system of claim 1, wherein the one or more beacons are individually configurable as a restricted-zone beacon and at least one of the one or more beacons is configurable as an allowed-use-zone beacon.

8. The system of claim 1, wherein once the one or more electronic devices have been determined to be in-zone, if the communication module subsequently becomes unable to receive the wireless location-based signal, the screen locking module continues to prevent access until a trusted unlock condition occurs.

9. A location-based electronic device screen-time limiting system comprising:
one or more electronic devices, each electronic device having an operating system that imposes background execution constraints;
a mobile application executable on the one or more electronic devices, wherein the mobile application includes a locking module, a communication module, and a screentime monitoring module; one or more beacons configured to transmit a wireless signal;
wherein the communication module includes a wireless scanning service configured to detect the wireless signal from the one or more beacons via a wireless advertising channel;
wherein the locking module is configured to restrict access to one or more applications on the one or more electronic devices upon detection of the wireless signal;
wherein the screentime monitoring module is configured to detect that the wireless scanning service has become interrupted;
wherein detecting that the wireless scanning service has become interrupted comprises at least one selected from the group consisting of:
detecting that the wireless scanning service has been terminated by the operating system;
detecting that a number of received wireless signals within a rolling time window has fallen below a minimum threshold; and
detecting that a wireless adapter on the respective electronic device has been disabled;
wherein upon detection that the wireless scanning service has become interrupted, the screentime monitoring module is configured to automatically initiate one or more recovery actions without requiring direct user intervention, the one or more recovery actions comprising at least one selected from the group consisting of:
detecting an attempt by a user to access one of the one or more restricted applications and reinitiating the wireless scanning service;
reinitiating the wireless scanning service via a background process; and
initiating one or more scheduled recovery events that periodically verify and restore the wireless scanning service; and
wherein after performing the one or more recovery actions, the screentime monitoring module re-determines whether the one or more electronic devices are within a coverage range of the one or more beacons and the locking module restricts access based on the re-determined zone state, and permits access when not within the coverage range.

10. The location-based electronic device screen-time limiting system of claim 9, wherein the screentime monitoring module detects the attempt to access one of the one or more restricted applications only when a current time falls within a predefined restriction schedule.

11. The location-based electronic device screen-time limiting system of claim 9, wherein the wireless scanning service detects the wireless signal via a Bluetooth advertising channel.

12. The location-based electronic device screen-time limiting system of claim 9, wherein the screentime monitoring module operates as a background process independent of the wireless scanning service.

13. The location-based electronic device screen-time limiting system of claim 9, wherein the screentime monitoring module is further configured to detect the attempt to access one of the one or more restricted applications based on at least one of: application launch, a predefined schedule, and a usage threshold.

14. A location-based electronic device screen-time limiting system comprising:
a plurality of electronic devices associated with a plurality of users;
a mobile application installed on each of the plurality of electronic devices, wherein the mobile application includes a locking module, a communication module, and a compliance verification module;
one or more beacons configured to transmit a wireless location-based signal, wherein the communication module of the mobile application is configured to receive the wireless location-based signal when a respective electronic device is within a coverage range of the one or more beacons;
wherein the locking module is configured to restrict access to the respective electronic device upon receipt of the wireless location-based signal;
a cloud-based server communicatively coupled to the plurality of electronic devices;
wherein the compliance verification module on each of the plurality of electronic devices is configured to determine an enforcement-active state indicating whether the respective electronic device is actively participating in restriction enforcement, determine a permission state indicating whether required restriction-related permissions and capabilities are enabled on the respective electronic device; and transmit a heartbeat signal to the cloud-based server, the heartbeat signal including data indicating the enforcement-active state and the permission state;
wherein the cloud-based server is configured to aggregate the heartbeat signals from the plurality of electronic devices; and provide compliance status data to an administrator; and
wherein the compliance status data indicates which of the plurality of electronic devices are actively enforcing restrictions and which have required permissions enabled.

15. The location-based electronic device screen-time limiting system of claim 14, wherein determining the permission state comprises at least one selected from the group consisting of:
querying an operating system interface to determine whether screentime restriction permissions are enabled; performing local optical character recognition on a screentime settings screen to validate which applications are selected for restriction; and querying a local validation module to verify restriction configuration.

16. The location-based electronic device screen-time limiting system of claim 14, wherein the compliance status data includes at least one of a percentage of uptime, a last active timestamp, and an identification of users with inactive restriction settings.

17. The location-based electronic device screen-time limiting system of claim 14, wherein the heartbeat signal is transmitted by at least one of the communication module, a screentime monitoring service, and a background process on the respective electronic device.

18. The location-based electronic device screen-time limiting system of claim 14, wherein the cloud-based server is further configured to provide an administrative dashboard displaying the compliance status data for the plurality of users.

19. The location-based electronic device screen-time limiting system of claim 14, wherein the administrator is associated with at least one of: a school, a business, and a family group.

20. The location-based electronic device screen-time limiting system of claim 14, wherein the one or more beacons are configured to transmit the wireless location-based signal only during predefined time periods.
